(19) United States
(12) Patent Application Publication
(10) Pub. No.: US 2004/0143059 A1
(43) Pub. Date: Jul. 22, 2004

(54) Process and apparatus for preparing emulsion polymers

(76) Inventor: Ivan Cabrera, Dreieich (DE)

Correspondence Address: MUSERLIAN AND LUCAS AND MERCANTI, LLP, 475 PARK AVENUE SOUTH, NEW YORK, NY, 10016, US

(21) Appl. No.: 10/753,207

(22) Filed: Jan. 7, 2004

(30) Foreign Application Priority Data
Jan. 17, 2003 (DE) 103 01 874.3

(51) Int. Cl. C08K 3/00

(52) U.S. Cl. 524/800

(57) ABSTRACT

The present invention relates to a process for preparing emulsion polymers, in which at least one monomer composition is introduced into a reactor and polymerized in a two-phase system, which comprises passing at least one monomer composition and at least one initiator composition into a micromixer via different supply lines and mixing them therein, the initiator composition being preheated, prior to its entry into the micromixer, to a temperature at which at least one of the initiators forms free radicals, and, after the mixture formed in the micromixer has emerged, polymerizing at least a fraction of the monomers.

The present invention relates to a process and apparatus for preparing emulsion polymers.

The preparation of emulsion polymers is well established. Emulsion polymerization involves a two-phase system wherein compounds—the monomers and the polymers formed from them, for example—are in dispersion, usually in water. An overview of emulsion polymerization is set out, for example, in “Reactions and Synthesis in Surfactant Systems” (Ed. John Texter), M. Dekker Surfactant Science Series, Vol. 100, 2001, Emulsion Polymerisation by K. Tauer.

On an industrial scale, emulsion polymers are normally prepared using batch or semibatch technology. These techniques have the customary drawbacks of this kind of process. For instance, very large reactors absolutely must be used. Moreover, regulation is relatively complex, and problems which occur are difficult to solve, since intervention can be made only after the reaction has started. Accordingly, the assurance of a consistent product quality is very difficult to make, and requires the acceptance of very high tolerances.

In relation to solution polymerization, a continuous preparation of polymers in this way, by means of micromixers, is known from DE 198 16 886 A1. That application describes the problem of part of the polymers prepared by solution polymerization possibly becoming insoluble in the solvent at high molecular weights. This high molecular weight fraction can come about, inter alia, as a result of poor initial mixing of monomers and initiator, and produces unwanted deposits in the reactor system. DE 198 16 886 A1 proposes solving this problem by preheating both the monomer solution and the initiator solution to the reaction temperature. This allows the formation of high molecular weight fractions within the microreactor to be successfully prevented. High molecular weight according to DE 198 16 886 A1 means that the molecular weight is >10⁵ g/mol. The preparation of greater molecular masses by solution polymerization techniques is very complex, since the viscosity increases very sharply as the molar mass goes up, so that even with a low polymer concentration the, systems exhibit a very high kinematic viscosity.

In contrast to the solution polymerization, emulsion polymerization is used to prepare polymers having very high molecular weights, >10⁷ for example. These high molecular weights are made possible by the fact that the viscosity of the emulsion is independent of the molar mass of the polymers. In comparison to other polymerization techniques, solution polymerization for example, the heterogeneous systems employed in the case of emulsion polymerization tend to increase formation of deposits when the equilibrium is disturbed, and this formation of deposits can be observed in the case of the known batch and semibatch technology.

Furthermore, the polymers obtained by means of solution polymerization are generally separated from the solvent, in the course of which residual monomers can be separated off. In contradistinction to this, the compositions obtained by emulsion polymerization are generally used without further purification, for reasons of cost. Some of the monomers used to prepare the emulsion polymers, however, are detrimental to health, and in many cases very strict limits apply. Accordingly, the residual monomer content of the resultant emulsions ought to be as low as possible without the need to use special purification processes.

The problems of solution polymerization and of emulsion polymerization, accordingly, are incomparable, since the heterogeneous emulsion polymerization systems have much more of a tendency to form deposits.

In view of the prior art indicated and discussed herein, then, it was an object of the present invention to specify processes for preparing emulsion polymers which can be conducted continuously. The emulsion polymers prepared in these processes ought to have a particularly consistent product quality.

A further object of the invention was to specify an emulsion polymerization process which can be carried out easily on a large scale.

A further object underlying the invention was that of providing a process for preparing emulsion polymers which is easy to manage and regulate.

Additionally it was an object of the present invention to provide a process which can be carried out particularly inexpensively, generally allowing any complicated regulations and controls which go beyond the customary extent to be dispensed with.

A further object, moreover, was to provide apparatus for conducting an emulsion process of this kind.

These objects, along with others which, although not stated explicitly, can be inferred, or arise automatically, as self-evident from the context discussed herein, are achieved by the processes for preparing emulsion polymers described in claim 1. Judicious modifications of the process of the invention are protected in the subclaims appendant to claim 1.

With regard to apparatus for conducting the process of the invention, claim 15 provides an achievement of the underlying object.

By passing at least one monomer composition and at least one initiator composition into a micromixer via different supply lines and mixing them therein, the initiator composition being preheated, prior to its entry into the micromixer, to a temperature at which at least one of the initiators forms free radicals, and, after the mixture formed in the micromixer has emerged, polymerizing at least a fraction of the monomers, it is possible to provide processes for preparing emulsion polymers in which at least one monomer composition is fed to a reactor and polymerized in a two-phase system, which processes can be conducted continuously.

The measures in accordance with the invention obtain the following advantages in particular (among others):

The process allows emulsion polymers to be prepared with a particularly consistent product quality.

Further, the emulsion polymerization process can be conducted easily on a large scale.

Furthermore, the process for preparing emulsion polymers is easy to manage.

Additionally, the process of the present invention can be carried out in a particularly cost-effective fashion, generally allowing any complex regulations and controls which exceed the normal extent to be dispensed with.

Moreover, the process of the present invention provides polymer dispersions having a particularly low residual monomer content.

In the process of the present invention monomers are polymerized in a two-phase system. Generally speaking, one of these phases comprises water and the other phase comprises an organic compound of poor solubility in water. The continuous phase generally comprises water, whereas the organic phase is in dispersion in this aqueous phase. Also known, however, are inverse systems with which an emulsion polymerization can be conducted (cf. Ullmann's Encyclopedia of Industrial Chemistry, 5th edition on CDROM, headword “emulsion polymerization”).

Systems of this kind are widely known among those in the art and are described in, for example, Encyclopedia of Polymer Science and Engineering, Vol. 8, p. 659 ff. (1987); D. C. Blackley, in High Polymer Latices, Vol. 1, p. 35 ff. (1966); H. Warson, The Applications of Synthetic Resin Emulsions, page 246 ff., chapter 5 (1972); D. Diederich, Chemie in unserer Zeit 24, pp. 135 to 142 (1990); Emulsion Polymerization, Interscience Publishers, New York (1965); DE-A 40 03 422, and Dispersionen synthetischer Hochpolymer, F. Hölscher, SpringerVerlag, Berlin (1969). Emulsion polymerizations are preferably conducted in aqueous phase in order to obtain aqueous polymer dispersions.

Aqueous polymer dispersions are fluid systems comprising polymer particles as disperse phase in stable disperse distribution in the aqueous dispersing medium. The diameter of the polymer particles is generally primarily in the range from 0.01 to 50 μm, frequently primarily in the range from 0.06 to 20 μm. The stability of the disperse distribution often extends over a period of at least 2 months, in many cases even over a period of at least 4 months, and with particular preference at least 6 months. Their polymer volume fraction, based on the total volume of the aqueous polymer dispersion, is normally from 10 to 70% by volume. Like polymer solutions when the solvent is evaporated, aqueous polymer dispersions have the property, when the aqueous dispersing medium is evaporated, of forming polymer films, which is why aqueous polymer dispersions are frequently employed as binders, for paints or for leather-coating compositions, for example.

In the process of the invention a monomer composition is passed into the micromixer via a feed line. The monomer composition includes at least one polymerizable compound, referred to below as monomer(s).

The monomers which can be used for emulsion polymerization are known among those in the art. It is preferred to use free-radically polymerizable monomers.

The monomers include, inter alia,

alkenes, examples being ethylene, propylene, and butylene;

vinyl halides, such as vinyl chloride, vinyl fluoride, vinylidene chloride, and vinylidene fluoride, for example;

vinyl esters, such as vinyl formate, vinyl acetate, vinyl propionate, vinyl isobutyrate, vinyl pivalate, vinyl 2-ethylhexanoate, vinyl esters of saturated branched monocarboxylic acids having 9 or 10 carbon atoms in the acid radical, vinyl esters of relatively long-chain saturated or unsaturated fatty acids such as, for example, vinyl laurate, vinyl stearate and also vinyl esters of benzoic acid and of substituted derivatives of benzoic acid,

such as vinyl p-tert-butylbenzoate; styrene, substituted styrenes having an alkyl substituent in the side chain, such as α-methylstyrene and α-ethylstyrene, substituted styrenes having an alkyl substituent in the ring, such as vinyltoluene and p-methylstyrene, and halogenated styrenes, such as monochlorostyrenes, dichlorostyrenes, tribromostyrenes, and tetrabromostyrenes, for example;

heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinyl-pyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, and vinyloxazoles and hydrogenated vinyloxazoles;

vinyl ethers and isoprenyl ethers;

maleic acid derivatives, such as maleic anhydride, methylmaleic anhydride, maleimide, and methylmaleimide, for example;

dienes and polyethylenically unsaturated hydrocarbons, such as divinylbenzene, butadiene, isoprene, diallyl phthalate, diallyl maleate, triallyl cyanurate, tetraallyloxyethane, butane-1,4-diol dimethacrylate, triethylene glycol dimethacrylate, divinyl adipate, allyl(meth)acrylate, vinyl crotonate, methylenebisacrylamide, hexanediol diacrylate, pentaerythritol diacrylate, and trimethylolpropane triacrylate;

monomers having N-functional groups, especially (meth)acrylamide, allyl carbamate, acrylonitrile, N-methylol(meth)acrylamide, N-methylolallyl-carbamate and also the N-methylol esters, alkyl ethers or Mannich bases of N-methylol(meth)acrylamide or of N-methylolallylcarbamate, acrylamido-glycolic acid, methyl acrylamidomethoxyacetate, N-(2,2-dimethoxy-1-hydroxyethyl)acrylamide, N-dimethylaminopropyl(meth)acrylamide, N-methyl(meth)acrylamide, N-butyl(meth)acrylamide, N-cyclohexyl-(meth)acrylamide, N-dodecyl(meth)acrylamide, N-benzyl(meth)acrylamide, p-hydroxyphenyl(meth)acrylamide, N-(3-hydroxy-2,2-dimethylpropyl)-methacrylamide, ethyl imidazolidone methacrylate, N-vinylformamide, and N-vinylpyrrolidone;

vinyl compounds containing an acetophenone group and/or benzophenone group, preferred acetophenone and/or benzophenone monomers being described in EP-A-0 417 568;

vinyl compounds having an acid group and also the water-soluble salts thereof, such as vinylsulfonic acid, 1-acrylamido-2-methylpropanesulfonic acid, and vinylphosphonic acid, and also ethylenically unsaturated monocarboxylic and dicarboxylic acids, especially acrylic acid, methacrylic acid, maleic acid, fumaric acid, and itaconic acid;

and (meth)acrylates.

The expression “(meth)acrylates” embraces methacrylates and acrylates and also mixtures of both. These monomers are widely known. They include, inter alia,

(meth)acrylates which are derived from saturated alcohols, such as methyl(meth)acrylate, ethyl(meth)acrylate, propyl(meth)acrylate, butyl(meth)acrylate, pentyl(meth)acrylate, hexyl(meth)acrylate, 2-ethylhexyl(meth)acrylate, heptyl(meth)acrylate, 2-tert-butylheptyl(meth)acrylate, octyl(meth)acrylate, 3-isopropylheptyl(meth)acrylate, nonyl(meth)acrylate, decyl(meth)acrylate, undecyl(meth)acrylate, 5-methylundecyl(meth)acrylate, dodecyl(meth)acrylate, 2-methyidodecyl(meth)acrylate, tridecyl(meth)acrylate, 5-methyltridecyl(meth)acrylate, tetradecyl(meth)acrylate, pentadecyl(meth)acrylate, hexadecyl(meth)acrylate, 2-methylhexadecyl(meth)acrylate, heptadecyl(meth)acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate and/or eicosyltetratriacontyl(meth)acrylate, (meth)acrylates which are derived from unsaturated alcohols, such as oleyl (meth)acrylate, 2-propynyl(meth)acrylate, allyl(meth)acrylate, vinyl(meth)acrylate, for example, and so on;

amides and nitriles of (meth)acrylic acid, such as (meth)acrylamide, N-methylol(meth)acrylamide, N-(3-dimethylaminopropyl)(meth)acrylamide, N-(diethylphosphono)(meth)acrylamide, 1-methacryloylamido-2-methyl-2-propanol, N-(3-dibutylaminopropyl)(meth)acrylamide, N-t-butyl-N-(diethylphosphono)(meth)acrylamide, N,N-bis(2-diethylaminoethyl)(meth)acrylamide, 4-methacryloylamido-4-methyl-2-pentanol, acrylonitrile, methacryloylamidoacetonitrile, N-(methoxymethyl)(meth)acrylamide, N-(2-hydroxyethyl)(meth)acrylamide, N-(dimethylaminoethyl)(meth)acrylamide, N-methyl-N-phenyl(meth)acrylamide, N,N-diethyl(meth)acrylamide, N-acetyl(meth)acrylamide, N-methyl(meth)acrylamide, N,N-dimethyl(meth)acrylamide, N-isopropyl(meth)acrylamide,

aminoalkyl(meth)acrylates, such as tris(2-(meth)acryloyloxyethyl)amine, N-methylformamidoethyl(meth)acrylate, 3-diethylaminopropyl(meth)acrylate, 4-dipropylaminobutyl(meth)acrylate, 2-ureidoethyl(meth)acrylate,

other nitrogen-containing (meth)acrylates, such as N-((meth)acryloyloxyethyl)diisobutylketimine, 2-(meth)acryloyloxyethylmethylcyanamide, and cyanomethyl(meth)acrylate;

aryl(meth)acrylates, such as benzyl(meth)acrylate or phenyl(meth)acrylate, it being possible for the aryl radicals in each case to be unsubstituted or to be substituted up to four times;

carbonyl-containing methacrylates, such as 2-carboxyethyl(meth)acrylate, N-(2-methacryloyloxyethyl)-2-pyrrolidinone, N-(3-methacryloyloxypropyl)-2-pyrrolidinone, carboxymethyl(meth)acrylate, N-methacryloylmorpholine, oxazolidinylethyl(meth)acrylate, N-(methacryloyloxy)formamide, acetonyl(meth)acrylate, N-methacryloyl-2-pyrrolidinone; cycloalkyl(meth)acrylates, such as 3-vinylcyclohexyl(meth)acrylate and bornyl(meth)acrylate;

hydroxyalkyl(meth)acrylates, such as 3-hydroxypropyl(meth)acrylate, 3,4-dihydroxybutyl(meth)acrylate, 2-hydroxyethyl(meth)acrylate, 2-hydroxypropyl(meth)acrylate; glycol di(meth)acrylates, such as 1,4-butanediol(meth)acrylate;

methacrylates of ether alcohols, such as tetrahydrofurfuryl(meth)acrylate, vinyloxyethoxyethyl(meth)acrylate, methoxyethoxyethyl(meth)acrylate, 1-butoxypropyl(meth)acrylate, 1-methyl-(2-vinyloxy)ethyl(meth)acrylate, cyclohexyloxymethyl(meth)acrylate, methoxymethoxyethyl(meth)acrylate, benzyloxymethyl(meth)acrylate, furfuryl(meth)acrylate, 2-butoxyethyl(meth)acrylate, 2-ethoxyethoxymethyl(meth)acrylate, 2-ethoxyethyl(meth)acrylate, allyloxymethyl(meth)acrylate, 1-ethoxybutyl(meth)acrylate, methoxymethyl(meth)acrylate, 1-ethoxyethyl(meth)acrylate, ethoxymethyl(meth)acrylate;

methacrylates of halogenated alcohols, such as 2,3-dibromopropyl(meth)acrylate, 4-bromophenyl(meth)acrylate, 1,3-dichloro-2-propyl(meth)acrylate, 2-bromoethyl(meth)acrylate, 2-iodoethyl(meth)acrylate, chloromethyl(meth)acrylate;

oxiranyl(meth)acrylates, such as 10,11-epoxyundecyl(meth)acrylate, 2,3-epoxycyclohexyl(meth)acrylate, 2,3-epoxybutyl(meth)acrylate, 3,4-epoxybutyl(meth)acrylate, glycidyl(meth)acrylate;

phosphoros, boron and/or silicon methacrylates, such as 2-(dibutylphosphono)ethyl(meth)acrylate, 2,3-butylene(meth)acryloylethyl borate, 2-(dimethylphosphato)propyl(meth)acrylate, methyldiethoxy(meth)acryloylethoxysilane, 2-(ethylenephosphito)propyl(meth)acrylate, dimethylphosphinomethyl(meth)acrylate, dimethylphosphonoethyl(meth)acrylate, diethyl(meth)acryloyl phosphonate, diethylphosphatoethyl(meth)acrylate, dipropyl(meth)acryloyl phosphate;

sulfur-containing methacrylates, such as ethylsulfinylethyl(meth)acrylate, 4-thiocyanatobutyl(meth)acrylate, ethylsulfonylethyl(meth)acrylate, thiocyanatomethyl(meth)acrylate, methylsulfinylmethyl(meth)acrylate, and bis((meth)acryloyloxyethyl) sulfide;

tri(meth)acrylates, such as trimethylolpropane tri(meth)acrylate; heterocyclic(meth)acrylates, such as 2-(1-imidazolyl)ethyl(meth)acrylate, 2-(4-morpholinyl)ethyl(meth)acrylate, and 1-(2-methacryloyloxyethyl)-2-pyrrolidone.

The monomers set out above can be used individually or as a mixture.

In the case of aqueous polymer dispersions produced exclusively by the method of free-radical aqueous emulsion polymerization the afore-mentioned monomers, exhibiting a heightened stability in water, are normally copolymerized merely as modifying monomers, in amounts, based on the total amount of the monomers to be polymerized, of less than 50% by weight, generally from 0.5 to 20%, preferably from 1 to 10% by weight.

Besides the monomers the monomer composition may comprise further constituents. Included among these are emulsifiers and also protective colloids. Frequently the monomer composition is introduced in emulsion form into the micromixer.

Examples of suitable protective colloids are polyvinyl alcohols, cellulose derivatives or vinylpyrrolidone copolymers. A detailed description of further suitable protective colloids can be found in Houben-Weyl, Methoden der organischen Chemie, volume XIV/1, Makromolekulare Stoffe [Macromolecular compounds], Georg-Thieme-Verlag, Stuttgart, 1961, pp. 411 to 420.

Examples of customary emulsifiers include ethoxylated mono-, di-, and tri-alkylphenols (EO units [degree of ethoxylation]: 3 to 50, alkyl radical: C₄ to C₉), ethoxylated fatty alcohols (EO units: 3 to 50, alkyl radical: C₈ to C₃₆), and also alkali metal salts and ammonium salts of alkyl sulfates (alkyl radical: C₈ to C₁₂), of sulfuric monoesters with ethoxylated alkanols (EO units: 4 to 30, alkyl radical: C₁₂ to C₁₈) and with ethoxylated alkylphenols (EO units: 3 to 50, alkyl radical: C₄ to C₉), of alkylsulfonic acids (alkyl radical: C₁₂ to C,₈), and of alkylarylsulfonic acids (alkyl radical: C₉ to C₁₈). Further suitable emulsifiers can be found in Houben-Weyl, Methoden der organischen Chemie, volume XIV/1, Makromolekulare Stoffe, Georg-Thieme Verlag, Stuttgart, 1961, pages 192 to 208.

The emulsifiers and/or protective colloids can be anionic, cationic or nonionic in nature. Where mixtures of surface-active substances are used the individual components must of course be compatible with one another, something which in case of doubt can be checked by means of a few preliminary tests. Generally speaking, anionic emulsifiers are compatible with one another and with nonionic emulsifiers. The same applies to cationic emulsifiers, whereas anionic and cationic emulsifiers are usually incompatible with one another.

It is also possible, moreover, to use mixtures of emulsifiers and/or protective colloids.

The monomer composition may further comprise one or more initiators which are used for emulsion polymerization. These initiators are described in connection with the initiator composition.

The monomer composition preferably includes

from 9 to 90%, preferably from 30 to 80% by weight of monomers,

from 9 to 90%, preferably from 15 to 30% by weight of water,

from 0 to 5%, preferably from 1 to 3% by weight of emulsifiers and/or protective colloids, and

from 0 to 10%, preferably from 0.5 to 3% by weight of initiators.

The temperature of the monomer composition on entry into the micromixer can lie within wide ranges, the temperature preferably being chosen such that only minor polymerization, if any, takes place prior to entry into the micromixer.

Where the monomer composition includes one or more initiators, the temperature is preferably chosen such that the half-life of the initiator is at least 1 hour, in particular at least 5 hours, and with particular preference at least 10 hours.

In one particular embodiment the temperature of the monomer composition is at least 20° C. below the temperature of the initiator composition, in each case measured on entry into the micromixer.

In accordance with one particular aspect of the present invention the temperature of the monomer composition on entry into the micromixer is in the range from 10 to 80° C., preferably in the range from 20 to 60° C., without implied limitation.

In the process of the invention an initiator composition is passed into the micromixer via a feed line. The initiator composition includes at least one compound, also called initiator, which is capable of forming free radicals.

Customary initiators are used for the polymerization. In the case of free-radical polymerization in aqueous emulsion, these initiators are generally readily soluble in water; oil-soluble initiators are also in use. The commonplace initiators also include, inter alia, inorganic peroxides, such as hydrogen peroxide or alkali metal peroxodisulfates; organic peroxides, especially organic acyl peroxides such as dibenzoyl peroxide, dilauroyl peroxide, didecanoyl peroxide, and diisononanoyl peroxide, alkyl peresters such as t-butyl perpivalate, t-butyl per-2-ethylhexanoate, t-butyl permaleate, t-butyl peracetate, and t-butyl perbenzoate, and hydroperoxides such as t-butyl hydroperoxide;

azo compounds such as 2,2′-azobisisobutyronitrile, 2,2′-azobis(methyl isobutyrate), 2,2′-azobis(2,4-dimethylvaleronitrile), 2,2′-azobis(4-methoxy-2,4-dimethylvaleronitrile), 2,2′-azobis(N,N′-dimethyleneisobutyramidine)dihydrochloride, 2,2′-azobis(2-amidinopropane)dihydrochloride or 4,4′-azobis(4-cyanovaleric acid).

Also suitable are organic combination systems, composed of at least one organic reducing agent and at least one peroxide and/or hydroperoxide, e.g., t-butyl hydroperoxide and the Na salt of hydroxymethanesulfinic acid, and also combination systems further comprising a small amount of a metal compound which is soluble in the polymerization medium and whose metallic component is able to occur in a plurality of valence states, e.g., ascorbic acid/iron(II) sulfate/sodium peroxodisulfate, where the ascorbic acid is frequently replaced by the Na salt of hydroxymethanesulfinic acid, sodium sulfite, sodium hydrogen sulfite or sodium metabisulfite.

The initiators set out above can be used individually or as a mixture.

The initiator concentration of the initiator composition is preferably in the range from 0.01 to 5% by weight, in particular from 0.1 to 3% by weight, and more preferably from 0.18 to 0.5% by weight.

The initiator composition may further comprise additional constituents, especially water, emulsifiers and/or protective colloids.

In accordance with one particular aspect of the present invention water-soluble initiators are used in the form of aqueous solutions.

Preferred initiator compositions include

from 5 to 99.9%, preferably from 70 to 99% by weight of water,

from 0.1 to 95%, preferably from 1 to 20% by weight of initiator,

from 0 to 80%, preferably from 3 to 40% by weight of emulsifiers and/or protective colloids.

Prior to entry into the micromixer the initiator composition is preheated to a temperature at which free radicals are formed. This temperature is dependent on the decomposition characteristics of the initiator or initiators.

The temperature of the initiator composition on entry into the micromixer is preferably chosen such that the half-life of the initiator is at least 1 minute, in particular at least 5 minutes, and not more than 10 hours, in particular not more than 5 hours, and more preferably not more than 1 hour.

In general this temperature is situated in the range from 40° C. to 160° C., preferably from 60° C. to 100° C., without any implied restriction.

The volume ratio of initiator composition to monomer composition can fluctuate within wide ranges. This ratio can be controlled, for example, by way of the water content of the two compositions. This ratio is preferably in the range from 1:1 to 1:50, in particular from 1:2 to 1:10.

In accordance with the invention at least a fraction of the monomers is polymerized after the mixture has emerged from the micromixer. This fraction can range widely depending on the micromixer used. It is preferred to polymerize at least 60%, more preferably at least 80%, of the supplied monomers after the mixture formed has emerged from the microreactor. This fraction can be adjusted by way of the temperature and also of the flow rate. This fraction can be determined by an analysis of the mixture, relating the fraction of polymers formed to the fraction of monomers.

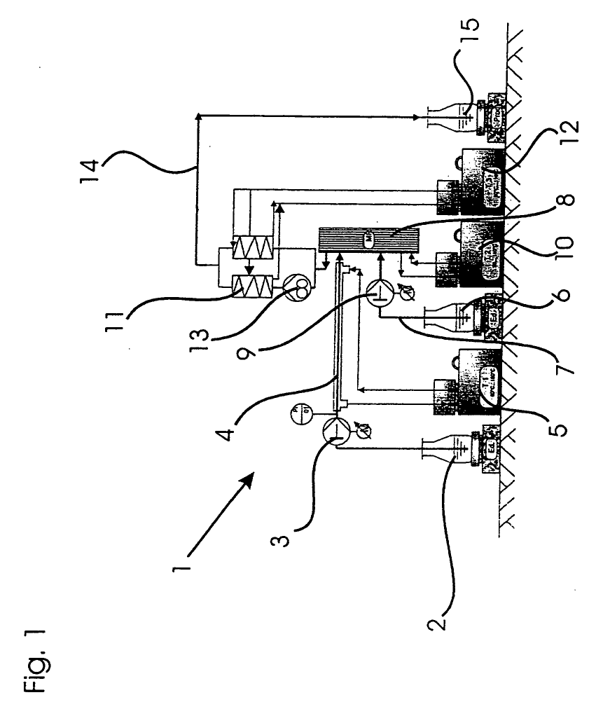

FIG. 1 depicts by way of example apparatus for implementing the method of the invention. The apparatus includes, among other components, two reservoir vessels 1 and 5 which are connected via at least two feed lines 3 and 7 to a micromixer, at least one of the feed lines 3 being heatable, and comprising a loop reactor.

FIG. 1 shows the flow diagram of apparatus 1 or plant for preparing emulsion polymers. Starting materials are a monomer composition, which is stored in reservoir vessel 6, and an initiator composition, which is present in reservoir vessels 2. The reservoir vessels 2 and 6 may contain a stirrer. The apparatus 1 may also be provided with means of forming an emulsion, which is then transferred to reservoir vessel 6.

The reservoir vessel 2 is connected via a heatable feed line 4 to the micromixer 8, which, like the reservoir vessel 6, can be charged with nitrogen, for example, in a way which has not been shown. Among other means, a pump 3 can be used to transfer the initiator mixture to the micromixer 8. It is also possible for a customary filter to be installed in the feed line 4. A thermostat 5, for example, can be used to heat the feed line.

The monomer composition flows from the reservoir vessel 6 via a feed line 7, in which a filter may have been installed to filter any impurities from the mixture, into a micromixer 8. The feed line 7 can be equipped with means for heating or cooling. A pump 9, whose regulation may be by electronic means, among other possibilities, can be used to supply the monomer composition from the reservoir vessel 6 via the feed line 7 to the micromixer 8.

The micromixer 8 is one of the various embodiments of micromixer available on the market. The micromixer can be heated by way of heating means. This can be done, for example, via a thermostat 10, and a closed circuit can be provided for the heating medium, for the purpose of heating.

The monomer composition and the initiator composition are fed to the micromixer 8 in a defined mixing ratio of, for example, from 1:1 to 10:1. These two reaction partners, or reactants, are passed through the micromixer and united in a mixing and reaction chamber of the micromixer. As a result of the upstream heated feed line 4 the initiator composition is heated such that on entry into the micromixer 8 free radicals are formed immediately. The reaction temperature in question here may generally be a temperature which is normally in the range from 60° C. to 180° C. The reaction temperature depends on the respective reactants and is not restricted to the above range.

The polymerization of the two reactants takes place further in the downstream loop reactor 11. For a given monomer composition, the molar masses and conversion can be adjusted by way of the respective initiator or its concentration and also by way of the heating of the tube reactor section and the delay time of the reactants in the loop reactor 11. The loop reactor 11 is normally heatable. Heating of the loop reactor 11 to the polymerization temperature can be accomplished, for example, by means of a thermostat 12. The reaction mixture can be circulated in the loop reactor 11 by means of a pump 13.

The loop reactor 11 is connected via a discharge line 14 to a discharge vessel 15 for the polymer dispersion. Disposed in the discharge line 14 there may be a regulating valve (not shown) which allows control of the operating pressure in the loop reactor 11. Flow to and from the loop reactor may be regulated electronically. The discharge vessel 15 may be equipped as a stirred vessel.

Loop reactors are known to the skilled worker. They are reactors in which the reaction mixture is circulated, with the quantity of reactant solution added to the reactor corresponding directly to the amount of product solution withdrawn. A description is given in, for example, K. Geddes, The Loop process, in Chemistry and Industry, 21.3.1983, p. 223 ff.

The apparatus, in particular the loop reactor, may be manufactured, among other materials, of metal, especially stainless steel, glass, ceramic, silicon or plastic.

The micromixers for use in the present process for emulsion polymerization are known to those in the art. The term “micromixer” used stands as a representative of micromixers and minimixers, which differ only in the dimensions and construction of the channel structures. Apparatus of this kind is also used for conducting reactions, and so such apparatus is also referred to as microreactors or minireactors.

In micromixers the reactant streams which are to be mixed, of which there are at least two, are united by way of very fine, lamellar channels in such a way that mixing of the reactants in the micro range occurs as soon as the flows strike one another. The construction of such a micromixer dictates the presence therein of extremely small channels, leading to an extremely high surface/volume ratio.

DD 246 257 A1 discloses the possibility of using miniaturized process engineering apparatuses for chemical reactions where the substances to be treated are available only in small quantities or are very expensive, so that large dead spaces in the process engineering apparatuses are unaffordable. DE 3 926 466 C2 describes strongly exothermic chemical reactions of two chemical substances in a microreactor. Microreactors for conducting chemical reactions are constructed from stacks of structured plates and are described in DE 39 26 466 C2 and U.S. Pat. No. 5,534,328. It is pointed out in U.S. Pat. No. 5,811,062 that microchannel reactors are preferably utilized for reactions that do not require or produce materials or solids that can clog the microchannels. DE 198 16886 describes solution polymerization apparatuses comprising micromixers. The reaction regime, however, is controlled so that no high molecular mass fractions are produced.

It is possible, for example, to use micromixers as known from the cited references or from publications of the Instituts für Mikrotechnik Mainz GmbH, Germany, or else commercially available micromixers, such as, for example, the Selecto™, based on Cytos™, from Cellular Process Chemistry GmbH, Frankfurt/Main.

The term “micromixer” used is representative of micromixers and minimixers, which differ only in the dimensions and construction of the reaction channel structures.

A micromixer may be constructed, inter alia, from a plurality of platelets which are stacked on top of one another, are connected to one another, and have surfaces on which there are structures, generated micromechanically, which interact to form mixing spaces and reaction spaces. Included is at least one channel which leads through the system and is connected to the inlet and to the outlet.

The flow rates of the materials are limited by the apparatus: for example, by the pressures which prevail in accordance with the geometric design of the micromixer. These values are heavily dependent on the type of micromixer used, and can be determined by means of simple tests; in the case of commercial products, they can be taken from the specifications.

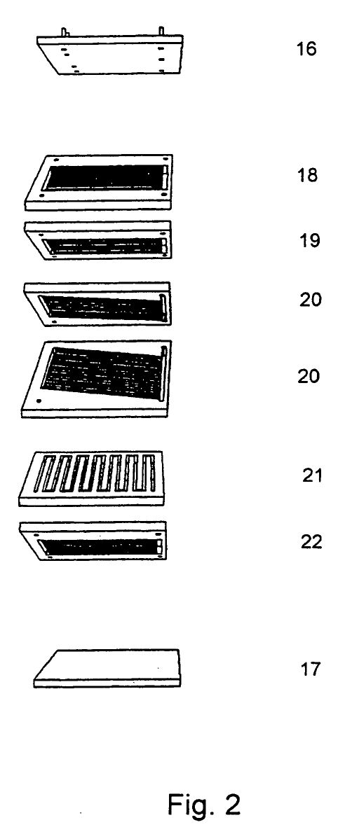

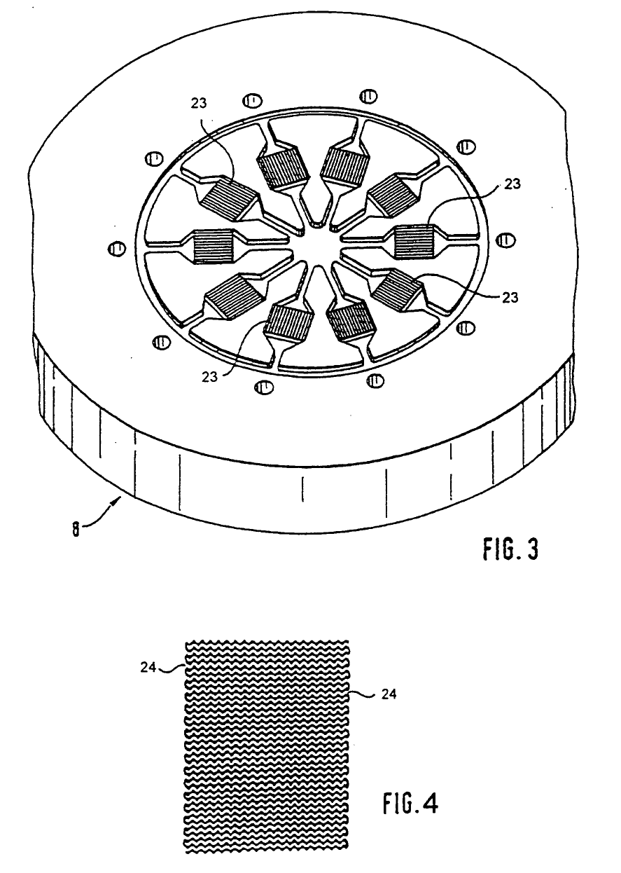

A microreactor 8 which can be used for emulsion polymerization is described by way of example in FIGS. 2 and 3.

FIG. 2 depicts a micromixer system which is, for example, a process engineering module constructed from six microstructured metal laminae, stacked on top of one another and connected to one another, each having a lid plate (16) and a base plate (17), and which by virtue of its assembly is held under pressure or firmly connected in order to compress sealing areas between the plates.

The micromixer system described in FIG. 2 includes two heat exchangers for cooling and/or heating medium, a mixing zone for mixing the reactants, and a short delay section.

The heat exchanger (18) can be used to preheat the reactant streams flowing separately into plate (19). The reactant streams are then mixed in the plates (20), which form a conjoint volume. In the delay zone (21) the mixture can be brought to a desired temperature by means of the heat exchanger (22).

The microreaction system can be operated continuously, and the fluid quantities which are mixed with each other in each case are in the microliter (μl) to milliliter (ml) range.

Advantageous for emulsion polymerization in this micromixer system are geometric designs which do not include any dead water zones, such as dead ends or sharp corners, for example, in which polymers formed in the micromixer can sediment. Preference is therefore given to continuous paths having round corners. The structures have to be sufficiently small to exploit the intrinsic advantages of the micromixer technology, namely out-standing heat control, laminar flow, diffuse mixing, and low internal volume.

The clear width of the solution-carrying or suspension-carrying channels is advantageously from 5 to 10 000 μm, preferably from 5 to 2 000 μm, more preferably from 10 to 800 μm, and in particular from 20 to 700 μm. The clear width of the heat exchanger channels is guided primarily by the clear width of the liquid-carrying or suspension-carrying channels and is advantageously less than or equal to 10 000 μm, preferably less than or equal to 2 000 μm, and in particular less than or equal to 800 μm. The lower limit for the clear width of the heat exchanger channels is uncritical and is at most constrained by the pressure increase of the heat exchanger fluid to be pumped and by the need for optimum heat supply or removal.

The dimensions of a micromixer system which can be used for the present process are as follows:

Heat exchanger structures:

channel width less than or equal to 600 μm,

channel height less than or equal to 250 μm;

Mixer:

channel width less than or equal to 600 μm,

channel height less than or equal to 500 μm.

The six superposed and closely interconnected metal laminae are supplied with all heat exchanger fluids and reactants preferably from above. The product and the heat exchanger fluids are likewise preferably removed upwardly. The supply of third and fourth liquids involved in the reaction, where approriate, is realized via a T-junction located directly upstream of the reactor. The required concentrations and flows are controlled preferably by means of precision piston pumps and a computer-controlled regulation system. The temperature is monitored via integrated sensors and monitored and controlled with the aid of the regulation system and of a thermostat/cryostat.

The preparation of mixtures of feedstocks to form streams of materials may also be carried out in advance in micromixers or in upstream mixing zones. It is also possible for feedstocks to be metered into downstream mixing zones or into downstream micromixers or microreactors.

FIG. 3 describes a further embodiment of a suitable micromixer.

FIG. 3 shows a perspective plan view of a micromixer 8, which is a static micromixer known per se. The micromixer 8 comprises a micromixer arrangement with a number of mixing units 23, which are arranged in a star shape. FIG. 4 shows a plan view of a mixing unit of the micromixer. The number of channels 24 per mixing unit is from 2×16 to 2×18. Within the micromixer 8 the reactants to be mixed with one another are united via the lamellar channels 24 in such a way that when the reaction streams occur the reactants are mixed in the micro region.

The materials of which the micromixers are manufactured are known to those in the art. Depending on the emulsion system the reactors may be manufactured, for example, of metal, especially stainless steel, glass, ceramic, silicon or plastics.

The invention is illustrated below with reference to examples, without any intention to restrict it thereby.

### EXAMPLE 1

A dispersion polymerization was conducted in apparatus depicted in FIG. 1: the initiator solution contained in reservoir vessel 2 was conveyed by the pump 3 at 1.0 ml/min and was passed into the microreactor 8 via the feed line 4, which is heated to a temperature of 120° C. by means of a thermostat 5. The monomer emulsion held in reservoir vessel 6 was pumped by the pump 9 at 2.4 ml/min into the microreactor 8, which was heated at 93° C. by the thermostat 10. The microreactor 8 opens out into the loop reactor 11, which is held at a temperature of 93° C. by means of the thermostat 12. The reaction mixture is circulated at 1.7 ml/min by means of the pump 13. Product is conveyed into the product vessel 15 only at the rate at which it is replaced by the pumps 3 and 9.

The constituents of the compositions used are listed in the tables below.

Initiator solution:

| Ingredients: | Parts by weight |
|---|---|
| Deionized water | 25.3 |
| ® Marlon A | 0.6 |
| Borax | 0.1 |
| Potassium persulfate | 0.3 |

Monomer emulsion:

| Ingredients: | Parts by weight |
|---|---|
| Deionized water | 58.9 |
| ® Marlon A | 0.4 |
| ® Akropal N230 | 2.0 |
| Borax | 0.49 |
| Potassium persulfate | 0.4 |
| Vinyl acetate | 80.0 |
| Versatic 10 acid vinyl ester | 20.0 |
| Acrylic acid | 1.0 |

The emulsifier ®Marlon A (benzenesulfonic acid, C₁₀-C₁₃ alkyl derivatives, sodium salt) is available commercially from Hüls AG. The emulsifier ®Akropal N230 (nonylphenol ethoxylate derivative) is available commercially from Clariant AG.

The resultant polymer dispersion was analyzed for residual monomers, the residual vinyl acetate monomer content being 0.09% by weight and the residual Versatic 10 acid vinyl ester monomer content being 0.03% by weight.

Additionally the particle size distribution was determined by photon correlation spectroscopy (PCS), the method being common knowledge (cf. R. Pecora, Editor, Dynamic Light Scattering: Application of Photon Correlation Spectroscopy (Plenum Press, N.Y. 1985)).

The particle size distribution and solids content are shown in table 1.

### EXAMPLE 2

Example 1 was essentially repeated, but using the following compositions:

Initiator solution:

| Ingredients: | Parts by weight |
|---|---|
| Deionized water | 53.4 |
| ® Emulsogen EPA 073 (28%) | 0.3 |
| Pre-emulsion (without APS) | 3.6 |
| Ammonium persulfate | 0.1 |

Monomer emulsion:

| Ingredients: | Parts by weight |
|---|---|
| Deionized water | 32.4 |
| ® Emulsogen EPA 073 (28%) | 1.0 |
| Methacrylic acid | 2.0 |
| Methyl methacrylate | 20.0 |
| Butyl acrylate | 80.0 |
| Ammonium persulfate | 0.3 |

The emulsifier ®Emulsogen EPA 073 (alkyl ether sulfate derivative, sodium salt) is available commercially from Clariant AG.

The product is adjusted using ammonia (12.5%) to a pH of 8.5.

The resultant polymer dispersion was analyzed for residual monomers, the residual methyl methacrylate monomer content being 0.02% by weight and the residual butyl acrylate monomer content being 0.11% by weight.

The particle size distribution and solids content are shown in table 1.

### COMPARATIVE EXAMPLE 1

Example 1 was essentially repeated, but with the initiator solution fed into the microreactor at room temperature.

The residual vinyl acetate monomer content was 18% by weight and the residual Versatic 10 acid vinyl ester monomer content was 34% by weight. The particle sizes and solids content are shown in table 1.

TABLE 1

| | |
|---|---|
| | Particle size |
| | distribution |
| Solids | according to PCS |

| Example. | [%] | dw [nm] | dw/dn |
|---|---|---|---|
| Example 1 | 51.9 | 190 | 1.3 |
| Example 2 | 46.0 | 117 | 1.23 |
| Comparative | 5.4 | 789 | |
| example 1 | | | |

What is claimed is:

1. A process for preparing emulsion polymers, in which at least one monomer composition is introduced into a reactor and polymerized in a two-phase system, which comprises passing at least one monomer composition and at least one initiator composition into a micromixer via different supply lines and mixing them therein, the initiator composition being preheated, prior to its entry into the micromixer, to a temperature at which at least one of the initiators forms free radicals, and, after the mixture formed in the micromixer has emerged, polymerizing at least a fraction of the monomers.

2. The process as claimed in claim 1, wherein the monomer composition comprises an initiator.

3. The process as claimed in claim 2, wherein the temperature of the monomer composition on entry into the micromixer is held below the decomposition temperature of the initiator present in the monomer composition.

4. The process as claimed in claim 3, wherein the temperature of the monomer composition on entry into the micromixer is in the range from 10 to 80° C.

5. The process as claimed in claim 1, wherein the temperature of the initiator composition on entry into the micromixer is in the range from 40 to 160° C.

6. The process as claimed in claim 1, wherein the temperature of the monomer composition is at least 20° C. below the temperature of the initiator composition, in each case measured on entry into the micromixer.

7. The process as claimed in claim 1, wherein the monomer composition and the initiator composition comprise water.

8. The process as claimed in claim 1, wherein the monomer composition and the initiator composition comprise at least one emulsifier.

9. Process as claimed in claim 1, wherein the volume ratio of initiator composition to monomer composition is in the range from 1:1 to 1:50.

10. The process as claimed in claim 1, wherein the initiator concentration of the initiator composition is in the range from 0.01 to 5% by weight.

11. The process as claimed in claim 1, wherein the initiator composition is a solution.

12. The process as claimed in claim 1, wherein the monomer composition is an emulsion.

13. The process as claimed in claim 1, wherein at least 80% of the monomers supplied are polymerized after the mixture formed has emerged from the microreactor.

14. The process as claimed in claim 1, wherein the polymerization following emergence from the micromixer is conducted in a loop reactor.

15. Apparatus for implementing the process as claimed in claim 1, comprising at least two reservoir vessels connected via at least two feed lines to a micromixer, at least one of the feed lines being heatable, wherein said apparatus comprises a loop reactor.

16. Apparatus as claimed in claim 15, wherein pumps are provided between the reservoir vessel and the micromixer.

17. Apparatus as claimed in claim 15, wherein at least one of the feed lines has a heat exchanger.

18. Apparatus as claimed in claim 15, wherein at least one of the reservoir vessels has means for preparing an emulsion.

19. Apparatus as claimed in claim 15, wherein the micromixer comprises heating means.
